(19) United States
(12) Patent Application Publication
(10) Pub. No.: US 2020/0274707 A1
(43) Pub. Date: Aug. 27, 2020

(54) SERVER FOR AND METHOD OF SECURE DEVICE REGISTRATION

(71) Applicant: Arm Limited, Cambridge (GB)

(72) Inventor: Janne Tuomas Kiiskilä, Oulu (FI)

(21) Appl. No.: 16/281,870

(22) Filed: Feb. 21, 2019

(51) Int. Cl. H04L 9/08; H04W 12/04

(52) U.S. Cl. CPC H04L 9/0869; H04L 9/0894; G06F 8/63; H04L 9/088; H04W 12/04031; H04L 9/0819

(57) ABSTRACT

A machine implemented method for securely registering a device with a server, the method comprising: installing at a device a registration software image comprising a pre-shared key ID for identifying the device and an API key for verifying the device with a server; generating, at the device, a pre-shared key and storing the pre-shared key and pre-shared key ID in a first memory space; and transmitting the API key, the pre-shared key, and pre-shared key ID to the server for registration.

The present techniques generally relate to a cryptographically secure method of generating a pre-shared key (PSK) for devices prior to starting encrypted bootstrap connection.

Present techniques also generally relate to a server and device configured for carrying out the method.

The Internet of Things encompasses devices and networks that are IP-enabled and Internet-connected, along with the Internet services monitoring and controlling those devices. Such IP-enabled devices connected to the Internet may be termed data processing devices, end nodes, remote devices or Internet of Things (IoT) devices and include sensors, machines, active positioning tags, radio-frequency identification (RFID) readers and building automation equipment to name but a few. Data exchange between programs, computers and Machine-to-Machine (M2M) is a vital element of the Internet of Things and different programs, computers and processors are used in different environments.

The Wireless Embedded Internet is a subset of the Internet of Things and is generally represented by resource-limited embedded devices, often battery powered and connected by low-power, low-bandwidth wireless networks to the Internet.

An example of a network technology where Machine-to-Machine (M2M) communication is widely applied is a low-power wireless network based on technical standard IEEE 802.15 for operation of low-rate wireless personal area networks. More recently, as M2M devices have become IP enabled, systems have become more open by using IP as a networking protocol.

Following the introduction of IEEE 802.15.4, other standards were developed to standardize an IP adaption for such wireless embedded links. For example, IPv6 over Low Power Wireless Standard (6LoWPAN) is a set of standards which enable the efficient use of IPv6 over low-power, low-rate wireless networks on simple embedded devices through an adaption layer and the optimization of related protocols.

The Open Mobile Alliance Lightweight M2M (LwM2M) is a standard applicable to 6LoWPAN and is focussed on constrained cellular and M2M devices. A LwM2M bootstrap process is used to provide mandatory information through the Bootstrap Interface for remote devices so that they can perform authentication and registration with one or more servers. Authentication and registration assigns a remote device to a server to access applications across a domain. A domain may be a logical grouping of devices and when the domain is exported to Domain Name System (DNS), then the domain value normally equates to the DNS domain name.

Authentication during registration may be achieved using a pre-shared key. The pre-shared key is injected into the device at the manufacturing stage, which brings a risk that the pre-shared key may be exposed or leaked to third parties at the manufacturing stage. If the original pre-shared key used for bootstrapping is leaked, then the device's security is compromised in a way that cannot be repaired without a recall of the device and a complete re-provisioning of a new pre-shared key.

The present applicant has recognised the need for an improved, and more secure method of generating a pre-shared key on a device so that authentication and registration of the device can be performed with greater security and confidence of device integrity.

According to a first technique, there is provided a machine implemented method for securely registering a device with a server, the method comprising: installing at a device a registration software image comprising a pre-shared key ID for identifying the device and an Application Programming Interface (API)-key for verifying the device with a server; generating, at the device, a pre-shared key and storing the pre-shared key and pre-shared key ID in a first memory space; and transmitting the API key, the pre-shared key, and pre-shared key ID for registration at the server.

Therefore, instead of injecting the pre-shared key into the device at manufacturing, present techniques may flash in a unique production image which contains a certificate for a cloud application programming interface (API) key and a pre-shared key ID. The API key may be used only for the creation of the pre-shared key and pre-shared key ID pair at the server, and nothing else. In further embodiments, the API key may be one time use only (for example, a unique API key per device) or there may be a limited number of devices in a production run (for example, a production run of 1000 devices uses an API key that allows generating only 1000 PSKs).

### BRIEF DESCRIPTION OF THE DRAWINGS

The techniques are diagrammatically illustrated, by way of example, in the accompanying drawings, in which:

FIG. 1a shows a deployment scenario for a plurality of devices requiring access to one or more services according to an embodiment;

FIG. 1b shows a schematic illustration of a device of FIG. 1a according to an embodiment;

FIG. 2a shows an architecture for communications between a device of FIG. 1a and a server according to an embodiment;

FIG. 2b shows objects/resources provided in the device of FIG. 2a;

FIG. 3 shows a flow chart of a method for manufacturing of a device according to an embodiment; and

FIG. 4 shows a flow chart of a method for manufacturing of a device with very limited resources according to an embodiment.

### DETAILED DESCRIPTION OF THE DRAWINGS

An Internet of Things (IoT) network comprises multiple connected devices and services (‘Things’) with different functionalities. The devices and services may be provided by different parties, and typically, the devices are resource-constrained with limited power supply, communication capability, CPU performance and memory. Generally speaking, bootstrapping processes include some or all of the steps that enable a new device to join a network and to communicate with a machine-to-machine (M2M) server. The bootstrapping processes include alerting a bootstrap server to the presence of a new device in a network, exchanging security credentials and authenticating the new device such that only permitted devices are able to join a network to enable secure communication between the M2M server and device.

A pre-shared key is used, for example, by a LwM2M server to authenticate the device, and to encrypt/decrypt messages sent between the device and the LwM2M server. Third party discovery of the pre-shared key presents a significant security risk, as once discovered, the key could be used to decrypt data/messages within the network and/or enable rogue, unauthorised devices to connect to the network and LwM2M server. The present technique provides a cryptographically secure method of generating a pre-shared key (PSK) for devices prior to starting encrypted bootstrap connection. Present techniques also generally relate to an apparatus, server and device configured for carrying out the method.

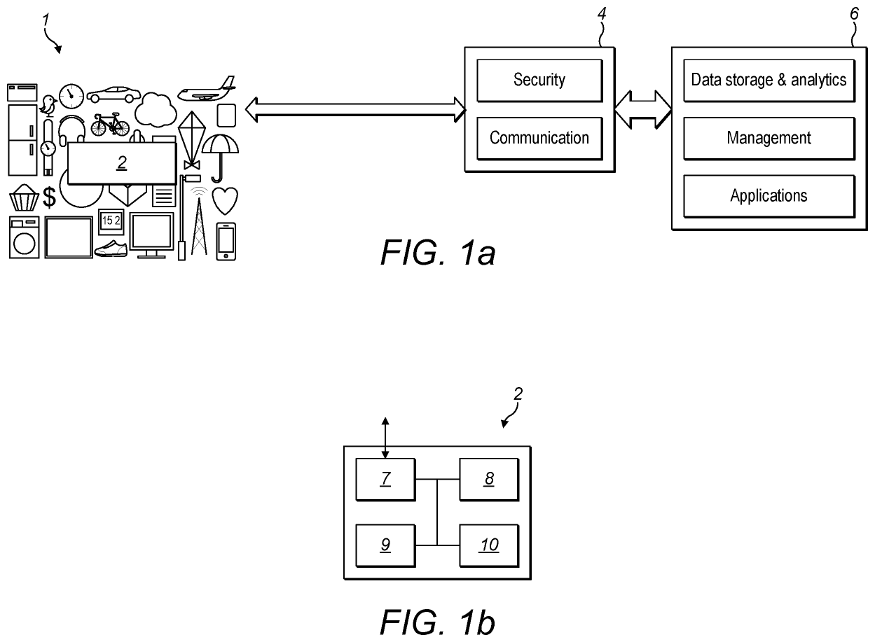

FIG. 1a shows a deployment scenario 1 for a plurality of devices 2, requiring access to one or more services communicating with a server 4, and FIG. 1b illustrates a device 2 according to an example.

Devices 2 may be a computer terminal, a laptop, a tablet or mobile-phone, or may, for example, be a lightweight machine to machine (LwM2M) device used to turn objects into “smart-objects” such as streetlights, electric meters, temperature sensors and building automation as part of the IoT, and a range of devices are illustratively depicted in FIG. 1a. It will be appreciated that the depictions of devices 2 shown in FIG. 1a are for illustrative purposes only and FIG. 1a does not show an exhaustive list of such devices.

Referring to FIG. 1b, the device 2 comprises communication circuitry 7 for communicating with remote devices such as the server 4 (FIG. 1a).

The communication circuitry 7 may use a wireless communication, such as communication using wireless local area network (Wi-Fi), short range communication such as radio frequency communication (RFID) or near field communication (NFC), or communications used in wireless technologies such as ZigBee, Thread, Bluetooth, Bluetooth LE, IPv6 over Low Power Wireless Standard (6LoWPAN) or Constrained Application Protocol (CoAP). Also, the communication circuitry may use a cellular network such as 3G or 4G. The communication circuitry may also use wired communication such as using a fibre optic or metal cable. The communication circuitry could also use two or more different forms of communication, such as several of the examples given above in combination.

The device 2 further comprises processing circuitry 8 for controlling various processing operations performed by the device 2, such as validation of connection data from a remote device and generating connection data at the device 2 for transmission to a remote device.

The device 2 further comprises storage circuitry 9 for storing data and information, whereby the storage circuitry 9 may comprise volatile and/or non-volatile memory.

The device 2 further comprises input/output circuitry 10, such that the device can receive inputs (e.g. sensor inputs, measurement inputs etc.) and or generate outputs (e.g. audio/visual/control commands etc.).

The server 4 may be any device capable of providing server functionality for another device, for example to provide access to a service 6 with which it communicates or hosts, and may, for example, be a gateway device in a home, an edge server, a computer terminal, a laptop, a tablet or mobile-phone, or may, for example, be a device used to turn objects into “smart-objects”.

Devices 2 communicate with server 4 using appropriate standards or protocols such as open IETF standards including over a first network, such as, for example, a low-power wireless network using (6LoWPAN), although any suitable network may be used. It will be appreciated that intermediary devices, such as a gateway device, may be located between the devices 2 and server 4.

The server 4 communicates with service 6, which may, for example, be part of a private cloud or public cloud environment on the Internet or which may be hosted on the server, and which may provide different types of services such as data storage & analytics services, management services and application services, although this list is not exhaustive.

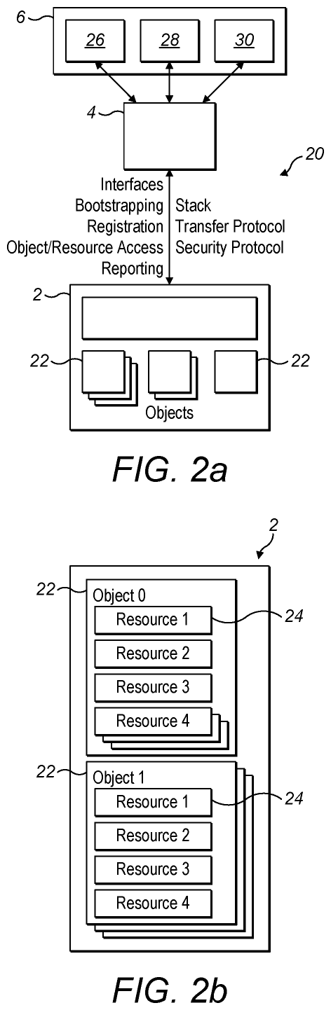

FIG. 2a illustratively shows an architecture 20, which in the present illustrative example is a LwM2M architecture 20, for providing a secure communications path or channel between device 2 and the server 4, which in the present illustrative example is an LwM2M server 4.

Logical interfaces between the device 2 and server 4 are defined, namely ‘Bootstrapping’ being pre-provisioned or device/server initiated; ‘Registration’ to register the device and its objects; ‘Object/Resource Access’ to enable server 4 access to an object 22 or resource 24; and ‘reporting’ for notifications with new resource 24 values. FIG. 2b illustratively shows different objects 22 provided on the device 2.

A protocol has a transfer protocol, which may for example be Constrained Application Protocol (CoAP) or may be HTTP or HTTPS, but any suitable transfer protocol may be used.

The LwM2M architecture 20 uses a security protocol(s) to establish a communications path or channel for providing secure communications between device 2 and server 4 for data/payloads. The security protocols may, for example comprise Transport Layer Security/Datagram Transport Layer Security (TLS/DTLS), whereby TLS/DTLS is used to provide a secure channel between the LwM2M server 4 and the device 2 whereby TLS/DTLS security modes include both pre-shared key and public key technology. The data (e.g. application data) protected by TLS/DTLS may be encoded as plain text, binary type-length-value (TLV), Javascript Object Notation (JSON), concise binary object representation (CBOR), or any other data exchange format suitable for use with IoT deployments.

It will be understood that the devices 2 may be remotely managed by, for example, M2M application developer 26, using, for example, a web application service 28 and/or a device management application 30 as part of service 6.

Referring to FIG. 2b, each piece of data or information made available by the device 2 is a resource 24, whereby a resource 24 is data that can be read, written or executed.

The resources 24 are further logically organized into objects 22. Each device 2 can have any number of resources 24, each of which belongs to an object 22. Each device 2 can have any number of objects 22.

As an example, a security object contains resources used to enable secure communications between device 2 and servers 4. Such resources may include connection data such as credential data. The resources may be provisioned at manufacture (e.g. during a factory bootstrapping process) or during a registration process with an operator.

The credential data may include certificates, trust anchors, pre-shared or raw public keys, and identifiers (e.g. direct or indirect identifiers) to identify a device (e.g. a server) or service, whereby the device 2 uses the server identifiers to register therewith. The credential data can be input to a TLS/DTLS security protocol to establish a secure communication path.

Trust anchors are certificates provisioned to the client and therefore trusted by the clients. These trust anchors are typically certificate authority (CA) certificates but they may also be pinned, end entity certificates.

Certificates require some form of identifier which may be used for verification purposes (e.g. to verify a certificate received from a remote device according to the identifier matching algorithm). As an example, when a device interacts with a remote device (e.g. a server) in order to authenticate it, then the algorithm may require two identifiers to match, namely the reference identifier (in the certificate stored on the device) needs to match the presented identifier (received from the remote resource). The detailed process of certificate parsing is described in RFC 5280.

When the identifier requires name resolution (hereinafter “an indirect identifier”), a name resolution service, such as DNS, may be used to find the corresponding address. However, when a device is unable to process the indirect identifier, for example when located in a residential environment without access to a public or private name resolution service, then the device would not be capable of locating another device using an indirect identifier and could not establish communications therewith.

Indirect identifiers include, a fully qualified domain name (FQDN), a Uniform Resource Locator (URL)), a Uniform Resource Indicator (URI) or a Uniform Resource Name (URN), although this is not an exhaustive list.

When the provisioned identifier does not require name resolution (hereinafter “a direct identifier”) such as an IP address (e.g. IPv4 or IPv6 address) the device can reach the address using the direct identifier.

Although not shown in FIG. 2a, further objects for device management purposes may include: a firmware object containing all the resources used for firmware update purposes; a server object defining data and functions related to the server 4; an access control object defining for the server 4 and each of several other permitted servers the access rights that each server has for each object 22 on the device 2; a device object for detailing resources on the device 2, for example, as related to device specific information whereby the device object allows remote retrieval of device information such as manufacturer, model, power information, free memory and error information.

Furthermore, the device object provides a resource for initiation of a remote reboot or factory reset; a location object grouping those resources that provide information about the current location of the device 2; a connectivity object grouping together resources on the device 2 that assists in monitoring the status of a network connection; and a connection statistics object grouping together resources on the device 2 that holds statistical information about an existing network connection.

As will be appreciated by a person skilled in the art, the objects and resources required by device 2 may be provisioned thereon, for example during a bootstrapping process via an apparatus such as a bootstrap server (not shown), or via an ‘out-of-band’ process, which uses a physical connection to provision the information on the device 2. Out-of-band provisioning can be wired by way of a USB interface for example. Alternatively, out-of-band provisioning can be wireless, for example, using a Near Field Communication (NFC) radio, Bluetooth® or BLE.

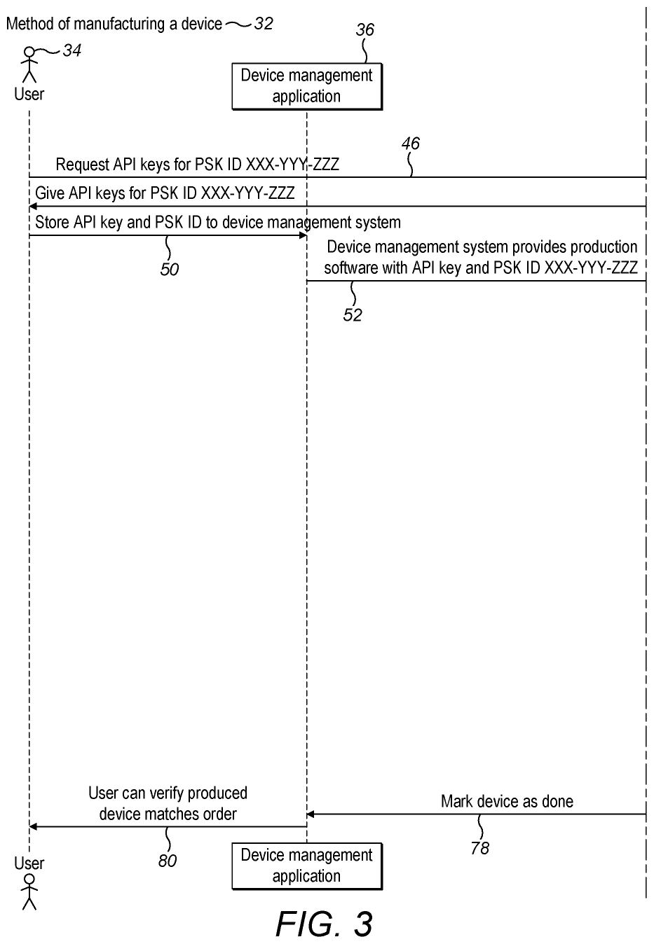

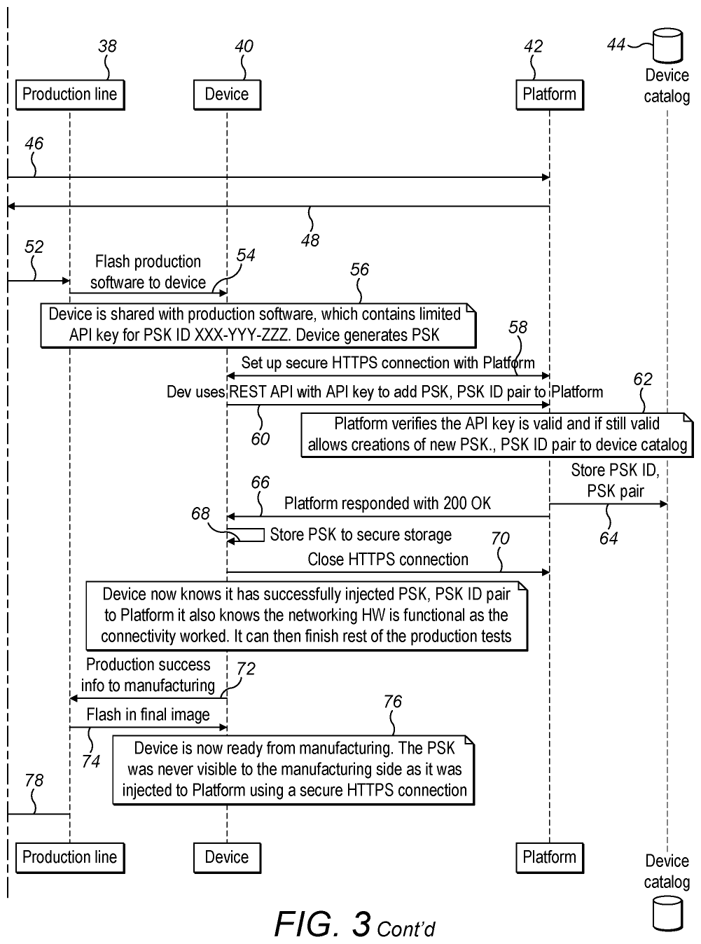

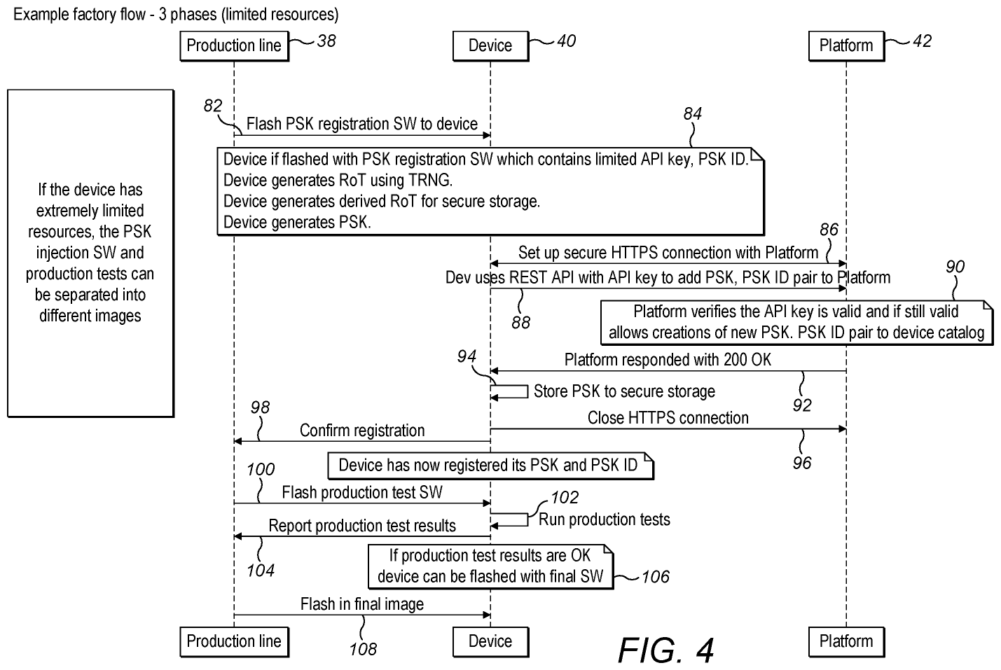

Referring to FIG. 3, a flow chart of a method for manufacturing 32 of a device 40 according to an embodiment comprises the elements of a user 34, device management application 36, manufacturing production line 38, device 40 with true random number generation capacity, IoT device management platform 42 and device catalogue 44. IoT device management platform 42 (sometimes shortened to platform 42) is a managed service system for interacting and managing with connected IoT devices over a secure connection. An example of platform 42 is Arm Mbed Cloud. Arm and Mbed are trademarks or registered trademarks of Arm Limited (or its subsidiaries) in the US and/or elsewhere.

The method starts with the user 34 making a request 46 for an application programming interface key (API key) for a specific and paired pre-shared key (PSK) ID, which may take many forms such as PSK ID XXX-YYY-ZZZ. The request for the API key is made to the IoT device management platform 42, which upon receipt of the request 46 returns 48 the requested API key for the PSK ID to the user 34. The user 34 at 50, stores the API key for the PSK ID in a memory store in the device management application 36. At 52, the device management application 36 provides production software to the manufacturing production line 38 along with the API key for the PSK ID. At 54, the production line 38 initiates a flash production of software onto the device 40. The method requires a memory capacity of around 64 kB, which can be 50% or more of the memory capacity required by known asymmetric key cryptography solutions. The software may comprise test code, for example, for a humidity sensor using memory for a REST (Representational State Transfer) API in addition to the API key and PSK ID. At 56, the device 40 generates a pre-shared key using a true random number generator (TRNG). The pre-shared key may be a 128-bit long secret or a 256-bit long secret and is stored to the same block where the PSK ID is stored. Optionally, the device may generate a root of trust using the true random number generator.

At 58, the device 40 connects to the IoT device management platform 42 by setting up a secure (e.g. HTTPS) connection. A HTTPS connection to the platform 42 ensures that the connection is safe and secure and should prevent any man-in-the-middle attacks, as is known to a person skilled in the art.

Additionally, as a further security provision, the API keys can be used to ensure that the number of devices 40 created match the number of devices 40 received. If a user 34 and platform 42 use the API keys in a one-device per API key agreement, then a match list is created of the PSK IDs and the API keys. If the match is 100% then the system is secure, if not, then a possible security breach has occurred.

Additionally, as a further security provision the API keys can be limited to making a predetermined number of specific pre-shared key (PSK) IDs, so that the number of devices 40 made in this way is known and fixed.

Accordingly, with the API key tied to the creation of one single device 40 with a known pre-determined PSK ID, each API key:
i. Can be used only once;
ii. Can be used only for creating a PSK for the PSK ID in question; and
iii. is associated with the customer account. If an API key was set to create “device_1” PSK then it can only create “device_1” and not “device_2” or another. If the API key is tied to “AB Corp” then is can only create the device for “AB Corp” there and not for “XY Corp” or another entity.

The device 40 makes a request at 60 using a Representational State Transfer (REST) API with the API key to add the PSK and its paired PSK ID to the platform 42. At 62, the platform 42 verifies that the API key is valid and if so allows entry and storage 64 of the PSK and its paired PSK ID to the device catalogue 44. At the point in the method, a trust relationship is formed between the device 40 and the platform 42 in the form of a shared secret. As is known to the skilled person, the platform can respond at 66 to the device 40 that the request 60 has succeeded using a 200 OK confirming that the request has been fulfilled and resulted in a new resource being created. The device 40 can then write the PSK to a secure storage section of memory at 68 and at 70 close the HTTPS connection with the platform 42.

At this point in the method, the device 40 is aware that it has successfully injected the PSK and PSK ID pair to the platform 42. Further, the device 40 is aware the networking hardware is functional, because the connectivity with the platform 42 worked. At 72, the device 40 affirms to the manufacturing production line that registration with the platform was successful and can run through and complete the remainder of the production tests at the manufacturing production line 38, which may comprise turning the sensor on and off and checking hardware operation.

At 74, on accordance with any manufacturing production line 38 protocols a final image is flashed onto the device 40 containing software such as an operating system, customer applications and cloud connection software.

At 76, the device 40 is now ready from manufacturing. According to present techniques, the PSK was never visible to the manufacturing production line 38 and was injected to the platform 42 using a secure HTTPS connection.

At 78, the manufacturing production line 38 can mark the device 40 as complete in a communication to the device management application platform 36 and the user 34 can verify at 80 that the produced device 40 matches the order.

Referring to FIG. 4, a flow chart of a method for manufacturing of a device with very limited resources according to an embodiment provides that the PSK injection software and production tests can be separated into different images. A device with limited resources may be a device with less than 64 kB of available memory storage or where the injection software requires more memory space than 64 kB can provide.

Accordingly, and using like reference numerals in FIG. 4 to represent like parts as described in FIG. 3, the manufacturing production line at 82 initiates a flash production of software onto the device 40 containing PSK registration software. The PSK registration software comprises an API key and a PSK ID. At 84, the device 40 generates a pre-shared key using a true random number generator. The pre-shared key may be a 128-bit long secret or a 256-bit long secret and is stored to the same block where the PSK ID is stored. Optionally, the device may generate a root of trust using the true random number generator and a derived root of trust for secure storage.

At 86, the device 40 connects to the IoT device management platform 42 by setting up a secure HTTPS connection with the platform 42. The HTTPS connection to the platform 42 ensures that the connection is safe and secure and should prevent any man-in-the-middle attacks using HTTPS, as is known to a person skilled in the art.

Additionally, as a further security provision, the API keys can be used to ensure that the number of devices 40 created match the number of devices 40 received. If a user 34 and platform 42 use the API keys in a one-device 34 per API key agreement, then a match list is created of the PSK IDs and the API keys. If the match is 100% then the system is secure, if not, then a possible security breach has occurred.

Additionally, as a further security provision the API keys can be limited to making a predetermined number of specific pre-shared key (PSK) IDs, so that the number of devices 40 made in this way is known and fixed.

Accordingly, with the API key tied to the creation of one single device 40 with a known pre-determined PSK ID, the following protocol may be enabled:
a. Each API key can be used:
   i. Only once, and
   ii. Each API key can only create a predetermined PSK ID.

The device 40 makes a request at 88 using a Representational State Transfer (REST) API with the API key to add the PSK and its paired PSK ID to the platform 42. At 90, the platform 42 verifies that the API key is valid and if so allows entry and storage 64 of the PSK and its paired PSK ID to the device catalogue 44. At the point in the method, a trust relationship is formed between the device 40 and the platform 42 in the form of a shared secret. As is known to the skilled person, the platform can respond at 92 to the device 40 that the request 60 has succeeded using a 200 OK confirming that the request has been fulfilled and resulted in a new resource being created. The device 40 can then write the PSK to a secure storage section of memory at 94 and at 96 close the HTTPS connection with the platform 42.

At this point in the method, the device 40 is aware that it has successfully injected the PSK and PSK ID pair to the platform 42 and at 98 can confirm to the manufacturing production line 38 that registration with the platform was successful.

Accordingly, the manufacturing production line 38 may now flash production test software to the device 40 at 100 and the device 40 may run production tests at 102, reporting the production test results to the manufacturing production line 38 at 104. If the production test results are good at 106 then the device 40 can be flashed with a final software image at 108 containing software such as an operating system, customer applications and cloud connection software.

The device 40 is now ready from manufacturing and according to present techniques, the PSK never went to the manufacturing production line 38 and was injected to the platform 42 using a secure HTTPS connection.

Accordingly, present techniques provide a machine implemented method for securely registering a device with a server, the method comprising: installing at a device a registration software image comprising a pre-shared key ID for identifying the device and an API key for verifying the device with a server; generating, at the device, a pre-shared key and storing the pre-shared key and pre-shared key ID in a first memory space; and transmitting the API key, the pre-shared key, and pre-shared key ID to the server for registration.

Techniques also provide a method for securely registering a device with a server, the method comprising: receiving at a server an API key, a pre-shared key, and a pre-shared key ID for registration of the device, the pre-shared key being generated at the device; verifying, by the server that the API key is valid and, if so, writing the pre-shared key and pre-shared key ID to a register.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from the any inventive concept as defined in the appended claims.

Accordingly, some features of the disclosed embodiments are set out in the following numbered items:
1. A machine implemented method for securely registering a device with a server, the method comprising: installing at a device a registration software image comprising a pre-shared key ID for identifying the device and an API key for verifying the device with a server; generating, at the device, a pre-shared key and storing the pre-shared key and pre-shared key ID in a first memory space; and transmitting the API key, the pre-shared key, and pre-shared key ID to the server for registration.
2. The method of item 1, including installing, at the device, a production software image when the device the registration software image is installed.
3. The method of item 1, including installing, at the device, a production software image after registration of the device without overwriting the first memory space.
4. The method of item 1, wherein the device has a true random number generator module and the generating, at the device of the pre-shared key includes generating using the true random number generator module.
5. The method of item 1, wherein the API key is valid for a pre-determined, limited number of devices.
6. The method of item 5, wherein the API key is associated with an account ID.
7. The method of item 1, wherein the API key is uniquely associated with a device.
8. The method of item 1, including storing at a onetime programmable (OTP) register.
9. A method for securely registering a device with a server, the method comprising: receiving at a server an API key, a pre-shared key, and a pre-shared key ID for registration of the device, the pre-shared key being generated at the device; verifying, by the server that the API key is valid and, if so, writing the pre-shared key and pre-shared key ID of the device to a register.
10. The method of item 9, wherein verifying comprises comparing the API key against a list of generated API keys.
11. The method of item 10, wherein the list of generated API keys includes a catalogue of devices matched with a unique API key.
12. A device production line providing for a secure registration of a device with a server, the device production line comprising:
   a receiver for receiving an API key and a pre-shared key ID for registration of the device; flash production for flashing the API key. pre-shared key ID and key generator onto the device whereby a pre-shared key is generated at the device and verified by the server and written with the pre-shared key ID to a register.
13. A device providing for secure self-registration with a server, the device comprising: a receiver for receiving: an API key, a pre-shared key ID and key generator onto the device whereby during production the key generator uses the API key and pre-shared key ID to generate a pre-shared key at the device for verification by the server and then registration with the pre-shared key in a register.
14. The method of item 13, whereby the device is connected to the server using a physical connection.
15. The method of item 13, whereby the device is connected to the server using a secure wireless connection.
16. The method of item 13, whereby an API key is requested from the server using the pre-shared key ID.
17. A server providing for secure self-registration for a device comprising:
   a transmitter for transmitting: an API key on request using a pre-shared key ID whereby during production the device uses the API key and pre-shared key ID to generate a pre-shared key;
   a verifier for verifying the pre-shared key; and
   register for registering the device with the verified pre-shared key.

1. A machine implemented method for securely registering a device with a server, the method comprising: installing at a device a registration software image comprising a pre-shared key ID for identifying the device and an API key for verifying the device with a server; generating, at the device, a pre-shared key and storing the pre-shared key and pre-shared key ID in a first memory space; and transmitting the API key, the pre-shared key, and pre-shared key ID to the server for registration.

2. A method as claimed in claim 1, including installing, at the device, a production software image when the device the registration software image is installed.

3. A method as claimed in claim 1, including installing, at the device, a production software image after registration of the device without overwriting the first memory space.

4. A method as claimed in claim 1, wherein the device has a true random number generator module and the generating, at the device of the pre-shared key includes generating using the true random number generator module.

5. A method as claimed in claim 1, wherein the API key is valid for a pre-determined, limited number of devices.

6. A method as claimed in claim 5, wherein the API key is associated with an account ID.

7. A method as claimed in claim 1, wherein the API key is uniquely associated with a device.

8. A method as claimed in claim 1, including storing at a onetime programmable (OTP) register.

9. A method for securely registering a device with a server, the method comprising: receiving at a server an API key, a pre-shared key, and a pre-shared key ID for registration of the device, the pre-shared key being generated at the device; verifying, by the server that the API key is valid and, if so, writing the pre-shared key and pre-shared key ID of the device to a register.

10. A method as claimed in claim 9, wherein verifying comprises comparing the API key against a list of generated API keys.

11. A method as claimed in claim 10, wherein the list of generated API keys includes a catalogue of devices matched with a unique API key.

12. A device providing for secure self-registration with a server, the device comprising:
a receiver for receiving: an API key, a pre-shared key ID and key generator onto the device whereby during production the key generator uses the API key and pre-shared key ID to generate a pre-shared key at the device for verification by the server and then registration with the pre-shared key in a register.

13. A device according to claim 12 whereby the device is connected to the server using a physical connection.

14. A device according to claim 12 whereby the device is connected to the server using a secure wireless connection.

15. A device according to claim 12 whereby an API key is requested from the server using the pre-shared key ID.
